(19) United States
(12) Patent Application Publication
(10) Pub. No.: US 2011/0232028 A1
(43) Pub. Date: Sep. 29, 2011

(54) CASTER

(76) Inventor: Seung youl Lee, Chungcheongnam-do (KR)

(21) Appl. No.: 13/058,666

(22) PCT Filed: Aug. 11, 2010
(86) PCT No.: PCT/KR10/05283

§ 371 Date: Feb. 11, 2011

(30) Foreign Application Priority Data
Nov. 23, 2009 (KR) 10-2009-0113007
Jul. 8, 2010 (KR) 10-2010-0065940

(51) Int. Cl. B60B 33/00

(52) U.S. Cl. 16/45

(57) ABSTRACT

A caster for moving a thing is disclosed. The caster comprises a first rotary shaft which is installed at a plate on which a thing to be moved is positioned; a rotation body of which one portion is rotatably engaged to the first rotary shaft; a frame of which an upper side is rotatably connected to the other portion of the rotation body; and a wheel which is rotatably installed at a lower side of the frame.

### TECHNICAL FIELD

The present invention relates to a caster which is used to move a thing, and in particular to a caster which makes it possible to move a thing with the aid of a combination of a rotation body, first and second rotary shafts connected with the rotation body and a wheel rotary shaft, so the caster according to the present invention can rotate or move straight in any direction that a user wants.

### BACKGROUND ART

A conventional caster is formed of one rotary shaft or two rotary shafts. In case of a caster with one rotary shaft, since it is directed to driving only wheels, the caster is designed to move in either a forward direction or a backward direction.

In case of a caster with two rotary shafts for an easier direction change, one rotary shaft is mounted on a frame which supports wheel rotary shafts, and the rotary shaft is in parallel engaged to a lower side of a plate that will move a thing, so the frame, which supports the wheel rotary shafts, can rotate 360° about the plate. However the caster with two rotary shafts happens to roll randomly when it loose a balance of force applied to itself, so the caster can't move in a desired direction, which leads to needing more force when moving a thing.

In order to resolve the above problem, one rotary shaft mounted on the frame, which supports the wheel rotary shafts, is engaged to a lower side and a slope surface of a plate which is to move a thing, respectively, the rotation angle of the frame, which supports the wheel rotary shafts, is limited depending on the slope of the slope surface for thereby obtaining an easier movement in one direction. However when the rotary shaft of the caster is engaged to a lower side and a slope surface of a plate which is to move a thing, the caster cannot move in a backward direction due to its inherent physical limitation, and a lot of spaces is needed so that the plate can move over 90°.

In the conventional caster formed of two rotary shafts of which one shaft is disposed at a rolling wheel side and the other shaft is disposed on a frame which supports the one shaft while being parallel in an engagement with a plate which moves a thing like in a conventional mart cart or being engaged to a lower side of the plate at a slope side like an S-board, a kind of skateboard, the caster is advantageous when changing directions and rotating when it is engaged in parallel with the plate, but a straight movement in one direction is almost difficult, and when it is engaged to a slope surface with the plate, a straight movement is easy in one direction, but a backward movement is impossible and has a poor rotation performance.

### DISCLOSURE OF INVENTION

Accordingly, it is an object of the present invention to provide a caster which is invented so as to overcome the problems encountered in the conventional art and which makes it possible for a user to move a thing in a desired direction since it has an excellent performance in a direction change, a rotation and one direction straight movement even in a narrow space.

To achieve the above object, there is provided a caster which comprises a first rotary shaft which is installed at a plate on which a thing to be moved is positioned; a rotation body of which one portion is rotatably engaged to the first rotary shaft; a frame of which an upper side is rotatably connected to the other portion of the rotation body; and a wheel which is rotatably installed at a lower side of the frame.

Therefore, the first rotary shaft is rotatably engaged to the plate and the rotation body, respectively, so the rotation body can rotate 360° about the first rotary shaft, whereby the direction of a thing to be moved or transported can easily be changed and can be easily rotatable 360° even in the narrow space.

There is further provided a second rotary shaft which is installed at the other portion of the rotation body and is connected so that the frame is engaged at a certain inclination angle with respect to the rotation body.

The function of the second rotary shaft allows the frame, which supports the wheel rotary shafts, to return in the opposite direction that a moving thing travels and allows the wheel to be aligned in one direction for thereby obtaining a straight movement of a moving thing.

The rotation body is preferably installed while being inclined from the one portion of the rotation body connected to a first rotary shaft to the other portion of the same in such a manner that it is inclined with respect to the plate.

The movement in one direction can be made easier by matching the arrangement of the wheels with a traveling direction by installing the rotation body at an inclined angle.

Here, it is preferred that the rotation body has an inclination angle of 10˜45° with respect to the plate.

It is possible to make a straight movement of a moving thing easier with the aid of an alignment in one direction of the wheels by installing the rotation body at a certain inclination angle.

The rotation body comprises a horizontal part which is in parallel with the plate; and an inclination part which is downwardly installed while getting more inclined from the horizontal part to the other portion of the rotation body at a certain angle with respect to the plate.

The horizontal part of the rotation body defines a first rotary shaft connected with a plate on which a thing to be moved is placed, and the inclination part defines a second rotary shaft connected with the frame which supports the wheels to be rotated, so the rotation and direction changes of the moving thing can be made easier while obtaining a straight movement in one direction.

The inclination part of the rotation body has an inclination angle of 10˜45° with respect to the plate while helping an arrangement in one direction with respect to the plate for thereby facilitating an easier straight movement of a moving thing.

The frame is formed being inclined toward the wheels from the other portion of the rotation body so that the angle being formed from the rotation body can have an acute angle.

The arrangement of the wheels can be easily matched with the traveling direction with the aid of the inclined frame for thereby obtaining an easier movement in one direction.

In addition, the distance between the wheel rotary shaft and the second rotary shaft exceeds the distance between the first rotary shaft and the second rotary shaft.

When the distance between the wheel rotary shaft and the second rotary shaft exceeds the distance between the first rotary shaft and the second rotary shaft, one direction movement can be enhanced.

A stopper part is provided between the frame and the rotation body so as to limit the rotation range with respect to the rotation body of the frame.

It is possible to obtain a desired straight movement by limiting the rotation range of the frame with respect to the rotation body with the aid of the stopper part.

The rotation range of the frame can be set within a range of 180°.

Since the rotation range of the frame does not exceed 180°, it is possible to prevent over direction change and a desired straight movement.

The stopper part comprises a guide part which is formed at the rotation body for limiting a rotation range; and a stopper which is formed at the frame for being guided by means of the guide part.

The stopper part helps easily limit the rotation range of the frame with respect to the rotation body.

There is further provided a locking unit for selectively fixing the rotation body with respect to the plate.

One direction propulsion force can be enhanced by selectively fixing the rotation body to the plate with the aid of the locking unit, which results in a wider range of use.

The locking unit comprises an accommodation part installed at the rotation body with the aid of a support part; a locking protrusion which is movable up and down in the accommodation part; a locking protrusion guide which is formed at the accommodation part for thereby guiding the movement of the locking protrusion; a locking groove which is formed at the plate for the locking protrusion to be selectively inserted; and an elastic member which is installed at the accommodation part for elastically pressing the locking protrusion toward the locking groove.

The locking unit helps fix the rotation body to the plate or helps unfix the fixed state.

### Effects

According to the present invention, the rotation body can rotate 360° about the first rotary shaft, and the frame, which supports the wheels, can rotate 360° about the rotation body and the first rotary shaft which is installed at a plate on which a thing to be moved is positioned, so that it is possible for the plate, which supports the first rotary shaft, to rotate about the rotation body, which makes it possible to easily change the direction of the thing to be moved or transported. Since 360° rotation can be possible in place, a direction change can be performed in a narrow space.

Since the rotation body or frame can be installed at an inclined angle the arrangement of the wheels can be easily matched with the traveling direction for thereby improving a straight movement in one direction.

In addition, it is possible to obtain a desired straight movement by limiting the rotation angle of the frame which supports the wheel rotary shaft. Since the rotation range of the frame can be limited not to exceed 180° in the traveling direction, the decrease of the straight movement due to unnecessary rotation can be prevented while not interfering with the straight movement in the traveling direction.

When a large force is needed for movement in a still state because the weight of the thing to be moved is too large, the thing to be moved can be swung in left and right directions for thereby decreasing a friction coefficient on the contact surface between the wheels and floor, so it can be moved with a smaller force. Namely, the caster provides a pulley function among the first rotary shaft, the rotation body and the frame which supports the wheel rotary shaft.

The distance between the wheel rotary shaft and the second rotary shaft is larger than the distance between the first rotary shaft and the second rotary shaft, so one direction movement can be enhanced. In addition, the distance between the wheel rotary shaft and the second rotary shaft might be less than the distance between the first rotary shaft and the second rotary shaft. In this case, the rotational force can be enhanced, which results in an easier direction change. So the length of the frame including the wheel rotary shaft can change depending on the function and characteristic of the product to be applied to the caster.

Since a user can fix the rotation body to the plate by using a locking unit, the straight movement can be optimized when moving a remote distance.

The caster according to the present invention can be applied to an apparatus for moving a certain thing such as a skate board, an inline skate, a quick board, a baby cart, a shopping cart, a medical bed, a wheel chair, an industry cart and a lift table for the purpose of easily moving a thing.

### BRIEF DESCRIPTION OF THE DRAWINGS

The present invention will become better understood with reference to the accompanying drawings which are given only by way of illustration and thus are not limitative of the present invention, wherein;

FIG. 1 is a front view of a caster according to an embodiment of the present invention;

FIG. 2 is a perspective view illustrating a caster according to an embodiment of the present invention;

FIG. 3 is a cross sectional view illustrating a cross section profile cut along A-A′ of FIG. 2;

FIG. 4 is a plane view for describing a rotation range of a frame according to an embodiment of the present invention;

FIGS. 5 and 6 are enlarged cross sectional views of the locking units of FIGS. 1 to 3; and

FIGS. 7 and 8 are cross sectional views illustrating the positions of a wheel rotary shaft according to an embodiment of the present invention.

### MODES FOR CARRYING OUT THE INVENTION

The caster according to a preferred embodiment of the present invention will be described with reference to the accompanying drawings.

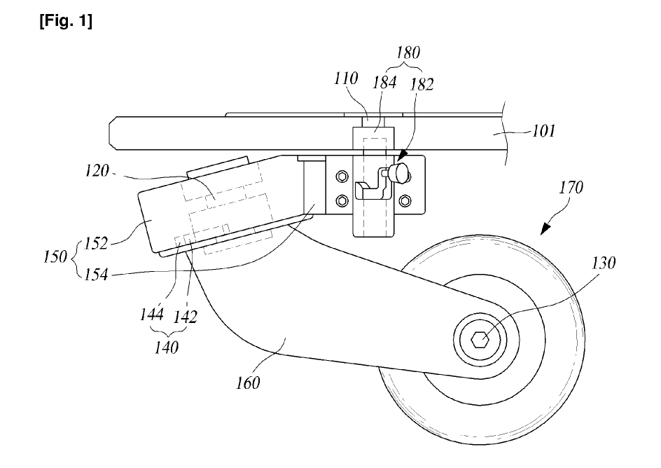

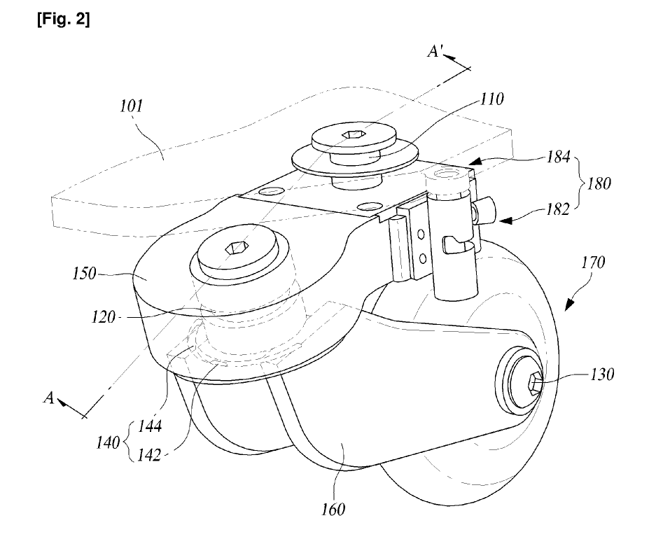

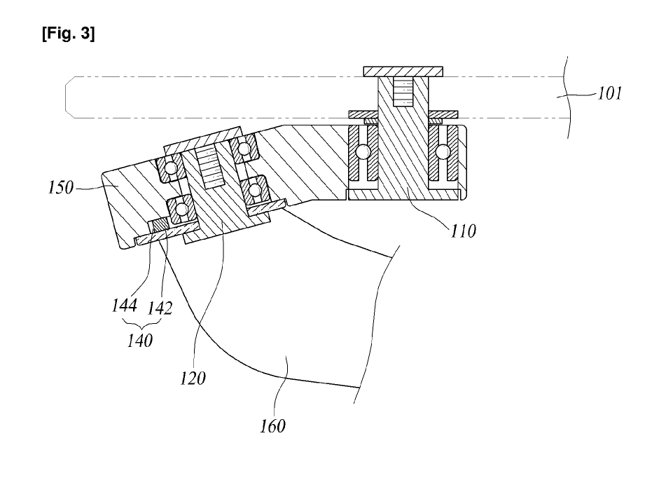

FIG. 1 is a front view of a caster according to an embodiment of the present invention, and FIG. 2 is a perspective view illustrating a caster according to an embodiment of the present invention, and FIG. 3 is a cross sectional view illustrating a cross section profile cut along A-A′ of FIG. 2. As shown in FIGS. 1 to 3, the caster according to the present invention comprises a first rotary shaft 110, a second rotary shaft 120, a rotation body 150, a frame 160, a wheel rotary shaft 130 and a wheel 170.

The first rotary shaft 110 is installed on the plate 101 on which a thing to be moved is placed. The rotation body 150 is rotatably engaged to the first rotary shaft 110. The upper side of the first rotary shaft 110 is fixed to the lower surface of the plate 101. The rotation body 150 is engaged to a lower side of the first rotary shaft 110. Bearings can be disposed between the first rotary shaft 110 and the rotation body 150. Bearings may not be used, and other members having similar functions with the bearings can be used. The rotation body 150 can rotate 360° about the first rotary shaft 110, so the plate 101 can change easily directions, and 360° rotation can be performed in a narrow place.

The rotation body 150 is inclined with respect to the plate 101 from the one portion of the rotation body 150 connected with the rotary shaft 110 to the other portion of the same. For example, the rotation body 150 may have an inclination in a range of 10˜45°. The propulsion force can be enhanced by increasing the inclination or the rotational force can be increased by lowering the inclination.

Here the rotation body 150 comprises a horizontal part 154 arranged in parallel with the plate 101, and an inclination part 152 downwardly inclined from one portion extended from the horizontal part 154 to the other portion of the rotation body 150 with respect to the plate 101. The inclination part 152 has an inclination angle of a range of 10˜45° with respect to the plate 101. The second rotary shaft 120 is installed at the inclination part 152 of the rotation body 150 and allows the frame 160 to rotate about the rotation body 150 for thereby enhancing the straight movement and propulsion force which helps the movement of a thing to be moved.

The second rotary shaft 120 is installed at the other portion of the rotation body 150, so that the frame 160 can be engaged at an inclination angle with respect to the rotation body 150. When the rotation body 150 has an inclination part 152, the second rotary shaft 120 is vertically engaged to the inclination part 152. The frame 160 is inclined toward the wheel 170 from the other portion of the rotation body 150 so that the angle from the rotation body 150 has an acute angle. In more detail, the upper side of the second rotary shaft 120 is connected rotatably with respect to the rotation body 150, and the lower side of the second rotary shaft 120 is engaged to the frame 160 which supports the wheel rotary shaft 130 and rotates together. Since the frame 160 connected with the second rotary shaft 120 is inclined and rotates, a thing to be moved can move straight in one direction. The movement and propulsion force in one direction can be enhanced by limiting the rotation range of the frame 160 which supports the wheel rotary shaft 130 depending on the inclination of the frame 160 with respect to the rotation body 150. For example, when the inclination of the frame 160 increases, the rotation range of the frame 160 is decreased, and on the contrary when the inclination decreases, the rotation range of the frame 160 is increased, so a thing can easily move straight in one direction by the inclination degree of the rotation body 150.

The wheel 170 is rotatably installed at the lower portion of the frame 160 via the wheel rotary shaft 130. The position of the wheel 170 can be changed depending on the length of the frame 160 connected with the second rotary shaft 120.

The distance between the first rotary shaft 110 and the second rotary shaft 120 may change depending on the length of the rotation body 150, and the first rotary shaft 110 and the second rotary shaft 120 may match in the rotation body 150.

A stopper part 140 may be further provided between the frame 160 and the rotation body 150 for limiting a rotation range with respect to the rotation body 150 of the frame 160.

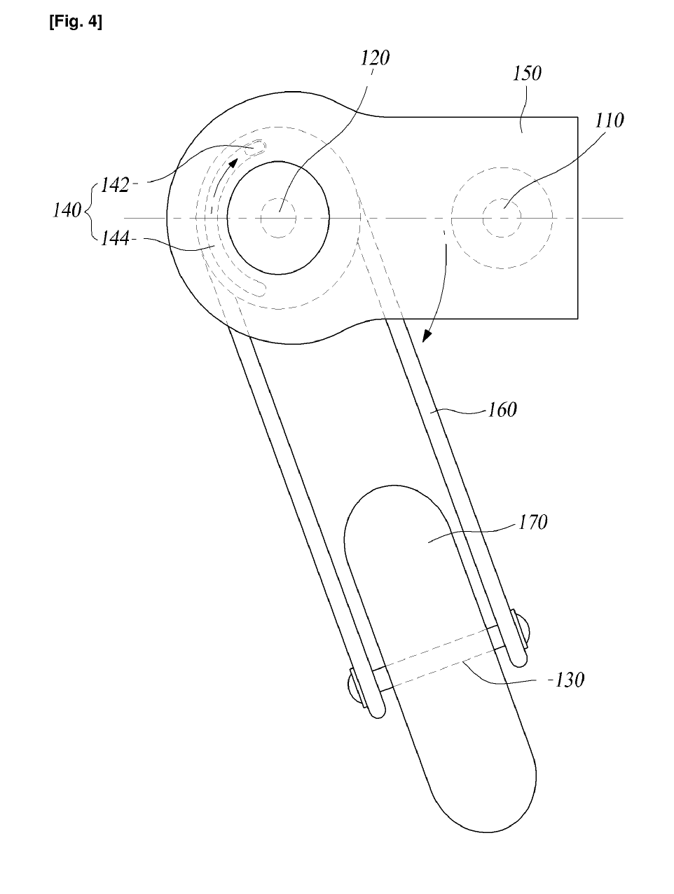

As shown in FIG. 4, a stopper part 140 may be installed between the frame 160 and the rotation body 150 for limiting a rotation range of the frame 160 with respect to the rotation body 150. The stopper part 140 includes a guide part 144 formed at the rotation body 150 for limiting a rotation range and a stopper 142 formed at the frame 160 for being guided inside the guide part 144. The guide part 144 can be installed by forming a circular groove at a lower surface of the rotation body 150. The stopper 142 is protruded from the frame 160 for being inserted into the guide part 144, so the stopper is guided in the guide part 144.

The stopper part 140 functions like limiting the rotation angle of the second rotary shaft 120 for smoothly limiting the travel in one direction. So it is preferred to set the rotation range in a range within 180° of the direction that a thing is to be moved. When the rotation range exceeds 180°, the rotation range may be extended, but the straight movement may be worsened.

As shown in FIG. 4, when the rotation range is set at 180°, the stopper 142 can freely rotate in the guide part 144 within a set range. The frame 160 has a rotation range which changes depending on the stopper 142. The rotation range of the frame 160 does not interfere with the straight movement in the traveling direction since it does not exceed 180°.

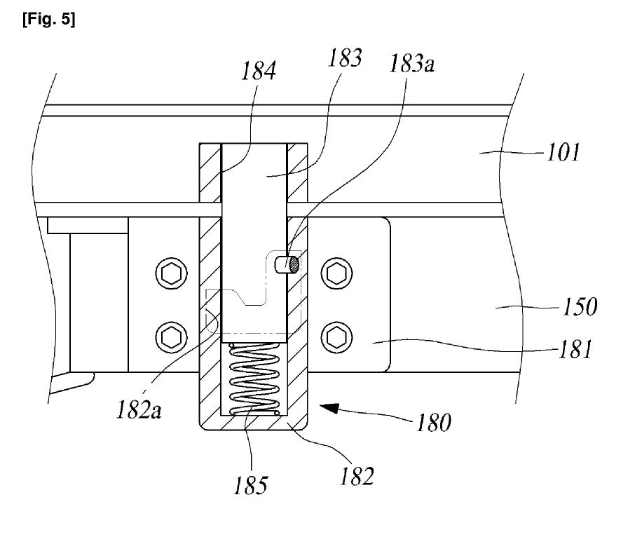

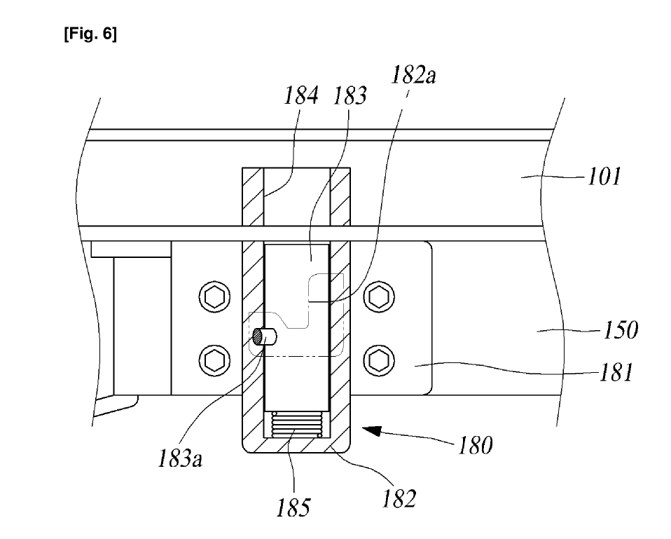

FIG. 5 is a cross sectional view of a state that the rotation body is fixed at the plate according to the present invention, and FIG. 6 is a cross sectional view of a state that the rotation body is released from the plate according to the present invention.

As shown in FIGS. 5 and 6, a locking unit 180 is installed at the plate 101 for selectively fixing the rotation body 150. The locking unit 180 includes an accommodation part 182, a locking protrusion 183, a locking protrusion guide 182a, a handle 183a, an elastic member 185 and a locking groove 184.

The accommodation part 182 is installed at the rotation body 150 with the aid of the support part 181. The support part 181 can be fixed at the rotation body 150 by screw engagement methods. The locking protrusion 183 can move upward and downward in the accommodation part 182. The locking protrusion guide 182a is formed at the accommodation part 182 for thereby guiding the movement of the locking protrusion 183. Here the locking groove 184 may be formed at the plate 101 for the locking protrusion 183 so that the locking protrusion 183 can be selectively inserted or may be installed in a form extended from the plate 101. The elastic member 185 is installed in the accommodation part 182. The locking protrusion 183 is elastically pressed toward the locking groove 184.

The handle 183a integral with the locking protrusion 183 is moved up and down along the locking protrusion guide 182a by using an elastic and recovery force of the elastic member 185 for inserting into or disengaging from the locking groove 184.

As shown in FIG. 5, when the locking protrusion 183 is moved to the upper side of the locking protrusion guide 182a, the locking protrusion 183 is inserted into the locking groove 184 by means of a recovery force of the elastic member 185. When the locking protrusion 183 is engaged to the locking groove 184, the rotation body 150 can be fixed to the plate 101. In a state that the rotation body 150 is fixed to the plate 101, a propulsion force increases, which helps travel in one direction.

As shown in FIG. 6, when the handle 183a is moved to the lower side of the locking protrusion guide 182a, the locking protrusion 183 escapes from the locking groove 184. When the locking protrusion 183 escapes from the locking groove 184, the rotation body 150 is separated from the plate 101. In a state that the rotation body 150 is separated from the plate 101, a rotational force increases, which helps quickly change a traveling direction.

Since the locking unit 180 is further provided, it is possible to enhance a propulsion force of the caster by selectively limiting the rotation of the rotation body 150 if necessary.

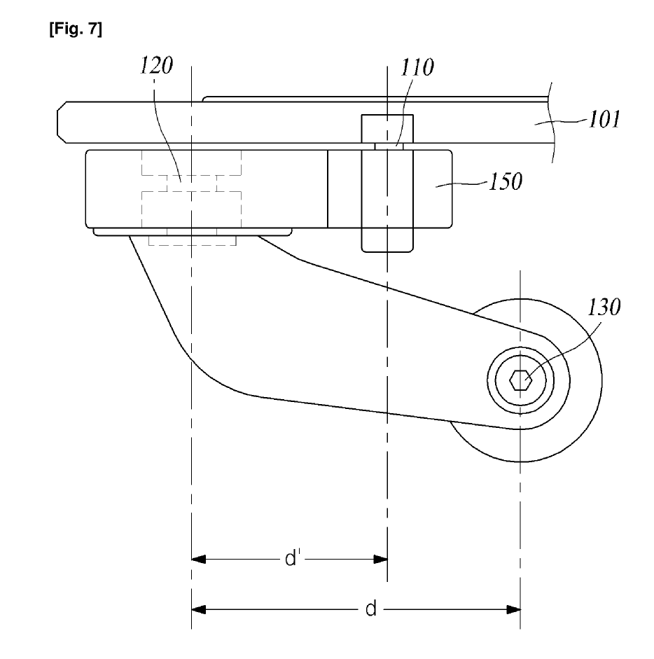

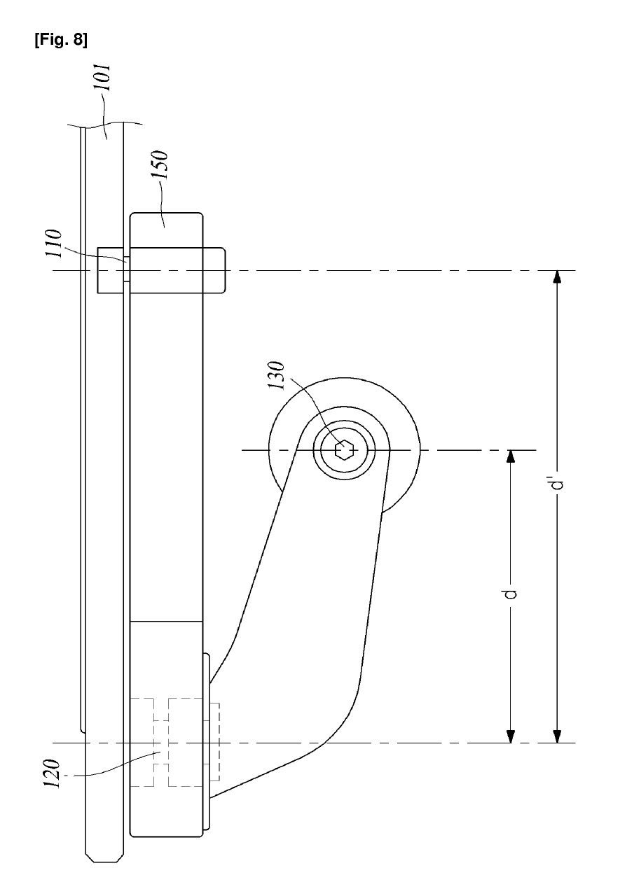

FIG. 7 is a view of a state when the wheel rotary shaft is positioned outside the first rotary shaft, and FIG. 8 is a view of a state when the wheel rotary shaft is positioned between the first rotary shaft and the second rotary shaft. Here the rotation body 150 can be in parallel with the plate 101.

As shown in FIG. 7, the wheel rotary shaft 130 is disposed outside the first rotary shaft 110. The distance d between the wheel rotary shaft 130 and the second rotary shaft 120 is larger than the distance d′ between the first rotary shaft 110 and the second rotary shaft 120. When the wheel rotary shaft 130 is disposed outside the rotary shaft 110, the straight movement is enhanced, and one direction travel is enhanced.

As shown in FIG. 8, the wheel rotary shaft 130 is disposed between the first rotary shaft 110 and the second rotary shaft 120. The distance d between the wheel rotary shaft 130 and the second rotary shaft 120 is less than the distance d′ between the first rotary shaft 110 and the second rotary shaft 120. When the wheel rotary shaft 130 is disposed between the first rotary shaft 110 and the second rotary shaft 120, the rotational force can be enhanced, so the direction change can be easier.

So, it is possible to change the position of the wheel rotary shaft 130 depending on the characteristic of the moving apparatus. In case of the apparatus which needs propulsion force, the wheel rotary shaft 130 is disposed outside the first rotary shaft 110, and in case of the moving apparatus which needs a direction change and rotation, the wheel rotary shaft 130 is disposed between the first rotary shaft 110 and the second rotary shaft 120.

The preferred embodiment of the present invention has been described like the first rotary shaft 110 is fixed at the plate 101 and is rotatable with respect to the rotation body 150 for the purpose of examples. In another example, the first rotary shaft 110 can be rotatably installed with respect to the plate 101 and can be fixed at the rotation body 150.

In case of the second rotation shaft 120, it has been described like it is rotatable between the rotation body 150 and the frame 160, but it was proposed for the purpose of examples. The second rotary shaft 120 can be fixed at the rotation body 150 and can be rotatable with respect to the frame 160. On the contrary, it can be rotatable with respect to the rotation body 150 and can be fixed at the frame 160.

The present invention can be applied to an apparatus for moving a certain thing such as a skate board, an inline skate, a quick board, a baby cart, a shopping cart, a medical bed, a wheel chair, an industry cart and a lift table for the purpose of easily moving a thing.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### DESCRIPTIONS OF REFERENCE NUMERALS

101: plate
110: first rotary shaft
120: second rotary shaft
130: wheel rotary shaft
140: stopper
150: rotation body
160: frame
170: wheel
180: locking unit

1. A caster, comprising:
a first rotary shaft which is installed at a plate on which a thing to be moved is positioned;
a rotation body of which one portion is rotatably engaged to the first rotary shaft;
a frame of which an upper side is rotatably connected to the other portion of the rotation body; and
a wheel which is rotatably installed at a lower side of the frame.

2. A caster according to claim 1, further comprising:
a second rotary shaft which is installed at the other portion of the rotation body and is connected so that the frame is engaged at a certain inclination angle with respect to the rotation body.

3. A caster according to claim 2, wherein said rotation body is downwardly installed while getting more inclined from one portion connected to the first rotary shaft to the other portion, at a certain inclination angle with respect to the plate.

4. A caster according to claim 2, wherein said rotation body comprises:
a horizontal part which is in parallel with the plate; and
an inclination part which is downwardly installed while being inclined from the horizontal part to the other portion of the rotation body at an inclination angle with respect to the plate.

5. A caster according to claim 3, wherein said rotation body is inclined at an angle of 10˜45° with respect to the plate.

6. A caster according to claim 1, wherein said frame is installed while getting more inclined from the other portion of the rotation body to the wheel with an acute angle being formed from the rotation body.

7. A caster according to claim 1, wherein the distance between the wheel rotary shaft and the second rotary shaft is larger than the distance between the first rotary shaft and the second rotary shaft.

8. A caster according to claim 1, wherein a stopper part is provided between the frame and the rotation body for limiting a rotation range with respect to the rotation body of the frame.

9. A caster according to claim 8, wherein said rotation range is in a range of 180°.

10. A caster according to claim 8, wherein said stopper part comprises:
a guide part which is formed at the rotation body for limiting a rotation range; and
a stopper which is formed at the frame for being guided by means of the guide part.

11. A caster according to claim 1, further comprising a locking unit for selectively fixing the rotation body with respect to the plate.

12. A caster according to claim 11, wherein said locking unit comprises:
an accommodation part installed at the rotation body with the aid of a support part;
a locking protrusion which is movable up and down in the accommodation part;
a locking protrusion guide which is formed at the accommodation part for thereby guiding the movement of the locking protrusion;
a locking groove which is formed at the plate for the locking protrusion to be selectively inserted; and
an elastic member which is installed at the accommodation part for elastically pressing the locking protrusion toward the locking groove.

13. A caster according to claim 4, wherein said rotation body is inclined at an angle of 10˜45° with respect to the plate.

14. A caster according to claim 2, wherein said frame is installed while getting more inclined from the other portion of the rotation body to the wheel with an acute angle being formed from the rotation body.

15. A caster according to claim 3, wherein said frame is installed while getting more inclined from the other portion of the rotation body to the wheel with an acute angle being formed from the rotation body.

16. A caster according to claim 4, wherein said frame is installed while getting more inclined from the other portion of the rotation body to the wheel with an acute angle being formed from the rotation body.

17. A caster according to claim 2, wherein the distance between the wheel rotary shaft and the second rotary shaft is larger than the distance between the first rotary shaft and the second rotary shaft.

18. A caster according to claim 3, wherein the distance between the wheel rotary shaft and the second rotary shaft is larger than the distance between the first rotary shaft and the second rotary shaft.

19. A caster according to claim 4, wherein the distance between the wheel rotary shaft and the second rotary shaft is larger than the distance between the first rotary shaft and the second rotary shaft.

20. A caster according to claim 2, further comprising a locking unit for selectively fixing the rotation body with respect to the plate.

21. A caster according to claim 20, wherein said locking unit comprises:
an accommodation part installed at the rotation body with the aid of a support part;
a locking protrusion which is movable up and down in the accommodation part;
a locking protrusion guide which is formed at the accommodation part for thereby guiding the movement of the locking protrusion;
a locking groove which is formed at the plate for the locking protrusion to be selectively inserted; and
an elastic member which is installed at the accommodation part for elastically pressing the locking protrusion toward the locking groove.

22. A caster according to claim 3, further comprising a locking unit for selectively fixing the rotation body with respect to the plate.

23. A caster according to claim 22, wherein said locking unit comprises:
an accommodation part installed at the rotation body with the aid of a support part;
a locking protrusion which is movable up and down in the accommodation part;
a locking protrusion guide which is formed at the accommodation part for thereby guiding the movement of the locking protrusion;
a locking groove which is formed at the plate for the locking protrusion to be selectively inserted; and
an elastic member which is installed at the accommodation part for elastically pressing the locking protrusion toward the locking groove.

24. A caster according to claim 4, further comprising a locking unit for selectively fixing the rotation body with respect to the plate.

25. A caster according to claim 24, wherein said locking unit comprises:
an accommodation part installed at the rotation body with the aid of a support part;
a locking protrusion which is movable up and down in the accommodation part;
a locking protrusion guide which is formed at the accommodation part for thereby guiding the movement of the locking protrusion;
a locking groove which is formed at the plate for the locking protrusion to be selectively inserted; and
an elastic member which is installed at the accommodation part for elastically pressing the locking protrusion toward the locking groove.
